(19) United States
(12) Patent Application Publication
(10) Pub. No.: US 2026/0347649 A1
(43) Pub. Date: Nov. 5, 2026

(54) SURFACE TREATMENT AGENT AND METHOD OF USING THE SAME

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); CHENG-LI CHAO, TAIPEI (TW); TZU-EN LIU, TAIPEI (TW)

(21) Appl. No.: 19/253,987

(22) Filed: Jun. 30, 2025

(30) Foreign Application Priority Data
May 2, 2025 (TW) 114116510

(51) Int. Cl. C09D 175/14; C08G 18/62; C08K 3/36; C09D 7/40; C09D 7/42; C09D 7/61; C09D 15/00

(52) U.S. Cl. CPC C09D 175/14; C08G 18/6283; C09D 7/42; C09D 7/61; C09D 7/69; C09D 15/00; C08K 3/36; C08K 2201/005

(57) ABSTRACT

A surface treatment agent and a method of using the same. The surface treatment agent is suitable for being applied on surfaces of wood grain building materials. The surface treatment agent is a two-component agent including a main agent and a curing agent. The main agent includes an acrylic resin formed by a copolymerization reaction of an acrylic monomer composition. The acrylic monomer composition includes: a first monomer (methyl methacrylate, MMA), a second monomer (2-hydroxyethyl methacrylate, 2-HEMA), a third monomer (ethylene glycol dimethacrylate, EGDMA), a fourth monomer (2-(dimethylamino)ethyl methacrylate, DMAEMA), and a fifth monomer (2-ethylhexanoic acid, 2-EHA). The acrylic resin has a glass transition temperature ranging from 20 °C to 60 °C and a weight average molecular weight ranging from 10,000 to 35,000 g/mol. The curing agent is an isocyanate hardener.

### CROSS-REFERENCE TO RELATED PATENT APPLICATION

This application claims the benefit of priority to Taiwan Patent Application No. 114116510, filed on May 2, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a surface treatment agent and particularly relates to a surface treatment agent and a method of using the same, which are suitable for being applied on surfaces of wood grain building materials.

### BACKGROUND OF THE DISCLOSURE

Surface treatment agents for building materials that are currently available on the market primarily utilize acrylic resin as the main agent. Although the acrylic resin provides advantages such as ease of application, conventional surface treatment agents generally exhibit poor scratch resistance and limited leveling performance.

### SUMMARY OF THE DISCLOSURE

An embodiment of the present disclosure provides a surface treatment agent, particularly suitable for being applied on wood grain or building material surfaces.

One of the objectives of the present disclosure is to overcome the inadequate scratch resistance commonly found in commercially available surface treatment agents for building materials, while simultaneously maintaining a high matting effect and desirable tactile properties. The surface treatment agent is especially suitable for wood grain building materials that require superior abrasion resistance.

In order to solve the above-mentioned problems, one of the technical aspects adopted by the present disclosure is to provide a surface treatment agent suitable for being applied on surfaces of wood grain building materials. The surface treatment agent is a two-component treatment agent that includes a main agent and a curing agent. The main agent includes an acrylic resin that is formed by a copolymerization reaction of an acrylic monomer composition. The curing agent is an isocyanate hardener. The acrylic monomer composition includes a first monomer, a second monomer, a third monomer, a fourth monomer, and a fifth monomer. The first monomer is methyl methacrylate (MMA). The second monomer is 2-hydroxyethyl methacrylate (2-HEMA). The third monomer is ethylene glycol dimethacrylate (EGDMA). The fourth monomer is 2-(dimethylamino)ethyl methacrylate (DMAEMA). The fifth monomer is 2-ethylhexanoic acid (2-EHA). The acrylic resin has a glass transition temperature ranging from 20 °C to 60 °C and a weight average molecular weight ranging from 10,000 g/mol to 35,000 g/mol.

In one of the possible or preferred embodiments, in the acrylic monomer composition, based on 100 parts by weight of the first monomer (MMA), an amount of the second monomer (2-HEMA) ranges from 30 to 50 parts by weight, an amount of the third monomer (EGDMA) ranges from 1 to 10 parts by weight, an amount of the fourth monomer (DMAEMA) ranges from 1 to 25 parts by weight, and an amount of the fifth monomer (2-EHA) ranges from 1 to 25 parts by weight.

In one of the possible or preferred embodiments, in the main agent, the acrylic monomer composition further includes a sixth monomer, which is styrene or a styrene-containing monomer, in which an amount of the sixth monomer ranges from 1 to 10 parts by weight.

In one of the possible or preferred embodiments, the acrylic resin has the glass transition temperature ranging from 25 °C to 55 °C and the weight average molecular weight ranging from 15,000 to 30,000 g/mol.

In one of the possible or preferred embodiments, the acrylic resin has the glass transition temperature ranging from 40 °C to 50 °C and the weight average molecular weight ranging from 15,000 to 25,000 g/mol.

In one of the possible or preferred embodiments, the acrylic resin is formed by the copolymerization reaction of the acrylic monomer composition in the presence of an organic solvent and an initiator.

In one of the possible or preferred embodiments, an amount of the curing agent ranges from 35 parts by weight to 65 parts by weight.

In one of the possible or preferred embodiments, the surface treatment agent further includes a matting powder, in which the matting powder is silica matting powder having an average particle size (d50) ranging from 5 μm to 15 μm, a tamped density ranging from 40 to 60 g/L according to ISO 787-11, and a silica content of not less than 99% according to ISO 3262-19.

In one of the possible or preferred embodiments, an amount of the matting powder ranges from 30 parts by weight to 60 parts by weight.

In order to solve the above-mentioned problems, another one of the technical aspects adopted by the present disclosure is to provide a method of using a surface treatment agent. The method includes a coating material preparation process and a coating and curing process. The coating material preparation process includes mixing the main agent and the curing agent of the surface treatment agent as mentioned above to form a coating material. The coating and curing process includes coating the coating material onto a surface of a substrate and curing the coating material to form a coating layer. The coating layer includes silica matting powder and has a gloss value of not greater than 6 GU.

In order to solve the above-mentioned problems, still another one of the technical aspects adopted by the present disclosure is to provide a surface treatment agent suitable for being applied on surfaces of wood grain building materials. The surface treatment agent is a two-component treatment agent that includes a main agent and a curing agent. The main agent includes an acrylic resin that is formed by a copolymerization reaction of an acrylic monomer composition. The curing agent is an isocyanate hardener. The acrylic monomer composition includes: a first monomer, a second monomer, a third monomer, a fourth monomer, and a fifth monomer. The first monomer is a methacrylate monomer. The second monomer is a hydroxyl-containing methacrylate monomer. The third monomer is a crosslinkable methacrylate monomer having bifunctional groups. The fourth monomer is a basic functional methacrylate monomer. The fifth monomer is a long-chain aliphatic acrylate monomer. The acrylic resin has a glass transition temperature ranging from 20 °C to 60 °C and a weight average molecular weight ranging from 10,000 to 35,000 g/mol.

Therefore, the surface treatment agent of the present disclosure exhibits improved scratch resistance while maintaining a high matting effect and proper tactile feel, which is applicable to wood grain building materials with high abrasion resistance requirements.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Surface Treatment Agent of First Embodiment]

Currently available surface treatment agents for building materials primarily utilize acrylic resin as the main agent. Although acrylic resin provides advantages such as ease of application, conventional surface treatment agents generally exhibit poor scratch resistance and poor leveling performance.

To address the problems existing in the related art, the first embodiment of the present disclosure provides a surface treatment agent particularly suitable for decorative films or similar coverings applied on the surfaces of wood grain or building materials. The objective of the surface treatment agent is to enhance the insufficient scratch resistance commonly observed in commercially available surface treatments for building materials, while simultaneously maintaining a high matting effect and desirable tactile properties. Thus, the surface treatment agent is suitable for being applied on wood grain building materials that require high abrasion resistance.

More specifically, the surface treatment agent is a two-component treatment agent including a main agent (i.e., component A) and a curing agent (i.e., component B). The main agent includes an acrylic resin, and the acrylic resin is formed by a copolymerization reaction of an acrylic monomer composition. The acrylic monomer composition includes: a first monomer (a), a second monomer (b), a third monomer (c), a fourth monomer (d), and a fifth monomer (e).

In the embodiment of the present disclosure, the first monomer (a) is methyl methacrylate (MMA). The first monomer is the primary acrylic monomer and provides essential physical properties of the surface treatment agent. The second monomer (b) is 2-hydroxyethyl methacrylate (2-HEMA), which has a hydroxyl group (—OH) that can enhance reactivity during the polymerization reaction.

The third monomer (c) is ethylene glycol dimethacrylate (EGDMA), which has bifunctional groups and serves as a crosslinking monomer to improve the adhesive viscosity of the surface treatment agent.

The fourth monomer (d) is 2-(dimethylamino)ethyl methacrylate (DMAEMA), which has an amino group. The amino group of the fourth monomer can react with the hydroxyl group of the second monomer (e.g., 2-HEMA), thereby increasing the degree of crosslinking of the polymerization reaction.

The fifth monomer (e) is 2-ethylhexanoic acid (2-EHA), which has an ethyl side chain capable of enhancing flexibility of the resin material, so as to prevent the final coating layer (coating film) from cracking or brittleness.

In some embodiments of the present disclosure, the acrylic monomer composition optionally further includes a sixth monomer (f), which is styrene or a styrene-containing monomer. The sixth monomer has a phenyl group, which improves the rigidity of the resin material.

In the acrylic monomer composition, based on 100 parts by weight of the first monomer (e.g., methyl methacrylate, MMA), an amount of the second monomer (e.g., 2-hydroxyethyl methacrylate, 2-HEMA) ranges from 30 parts by weight to 50 parts by weight, preferably ranges from 35 parts by weight to 45 parts by weight, and more preferably ranges from 35 parts by weight to 44 parts by weight.

An amount of the third monomer (e.g., ethylene glycol dimethacrylate, EGDMA) ranges from 1 part by weight to 10 parts by weight, preferably ranges from 3 parts by weight to 7 parts by weight, and more preferably ranges from 4 parts by weight to 6 parts by weight.

An amount of the fourth monomer (e.g., 2-(dimethylamino)ethyl methacrylate, DMAEMA) ranges from 1 part by weight to 25 parts by weight, preferably ranges from 1 part by weight to 20 parts by weight, and more preferably ranges from 2 parts by weight to 18 parts by weight.

An amount of the fifth monomer (e.g., 2-ethylhexanoic acid, 2-EHA) ranges from 1 part by weight to 25 parts by weight, preferably ranges from 2 parts by weight to 20 parts by weight, and more preferably ranges from 6 parts by weight to 16 parts by weight.

Additionally, when the sixth monomer (e.g., styrene) is included in the acrylic monomer composition, an amount of the sixth monomer ranges from 1 part by weight to 10 parts by weight, and preferably ranges from 1 to 5 parts by weight.

The acrylic resin is formed by copolymerizing the above-mentioned acrylic monomer composition (e.g., MMA, 2-HEMA, EGDMA, DMAEMA, and 2-EHA).

The acrylic resin, prior to coating and reaction with the curing agent, exhibits a liquid or flowable state and has a glass transition temperature (Tg) ranging from 20 °C to 60 °C, preferably from 25 °C to 55 °C, and more preferably from 40 °C to 50 °C.

Furthermore, the acrylic resin has a weight average molecular weight (Mw) ranging from 10,000 g/mol to 35,000 g/mol, preferably from 15,000 g/mol to 30,000 g/mol, and more preferably from 15,000 g/mol to 25,000 g/mol (e.g., 20,586 to 24,263 g/mol).

Within the above-mentioned ranges of glass transition temperature and molecular weight, the acrylic resin exhibits improved scratch resistance, and is suitable for surface coating applications.

If the glass transition temperature or the molecular weight of the acrylic resin is lower than the above range, the resulting acrylic resin coating layer (coating film) may be overly soft, resulting in increased susceptibility to scratching. Conversely, if the glass transition temperature or the molecular weight of the acrylic resin is higher than the above range, the surface treatment agent may become difficult to apply or lack flexibility.

It should be noted that the glass transition temperature (Tg) of the acrylic resin can be measured in accordance with ASTM E1356, which is the standard test method for determining the glass transition temperature of materials using differential scanning calorimetry (DSC).

Additionally, the weight average molecular weight (Mw) of the acrylic resin can be measured in accordance with ASTM D3536, which is the standard test method for determining the weight average molecular weight and molecular weight distribution of polymers using gel permeation chromatography (GPC).

Further, in one embodiment of the present disclosure, the acrylic resin is synthesized by copolymerizing the first monomer (e.g., MMA), the second monomer (e.g., 2-HEMA), the third monomer (e.g., EGDMA), the fourth monomer (e.g., DMAEMA), the fifth monomer (e.g., 2-EHA), and optionally the sixth monomer (e.g., styrene), together with an initiator (e.g., azobisisobutyronitrile, AIBN), and using specific organic solvents (e.g., methyl ethyl ketone, MEK; n-butyl acetate, BAC; and propylene glycol monomethyl ether acetate, PMA) as dispersing solvents for the monomers. The synthesis is carried out under controlled polymerization conditions (e.g., reaction temperature, reaction time, and component ratios). Based on 100 parts by weight of the first monomer (e.g., MMA), an amount of the organic solvent ranges from 50 parts by weight to 450 parts by weight, preferably ranges from 50 parts by weight to 230 parts by weight.

For example, the organic solvent can be a mixed solvent that contains methyl ethyl ketone (MEK) in an amount ranging from 50 to 150 parts by weight (preferably 30 to 90 parts by weight), n-butyl acetate (BAC) in an amount ranging from 50 to 150 parts by weight (preferably 60 to 120 parts by weight), and propylene glycol monomethyl ether acetate (PMA) in an amount ranging from 50 to 150 parts by weight (preferably 50 to 110 parts by weight), but the present disclosure is not limited thereto.

More specifically, the controlled polymerization conditions described above can include, for example, dispersing the first monomer (e.g., MMA), the second monomer (e.g., 2-HEMA), the third monomer (e.g., EGDMA), the fourth monomer (e.g., DMAEMA), the fifth monomer (e.g., 2-EHA), and the initiator (e.g., AIBN) in the mixed organic solvents (e.g., MEK, BAC, and PMA) to form a monomer solution. The polymerization reaction is then conducted using a semi-batch polymerization method at a reaction temperature ranging from 65 °C to 90 °C. The polymerization process includes a first stage and a second stage. In the first stage, 10% to 30% (by volume) of the monomer solution (e.g., 20%) is added dropwise over a period of 15 minutes to 45 minutes (e.g., 30 minutes) to provide initial nucleation and initiate the reaction. In the second stage, 70% to 90% (e.g., 80%) of the monomer solution is added dropwise over a period of 1.5 hours to 4.5 hours (e.g., 3 hours) to maintain a stable polymerization rate, control molecular weight distribution, and achieve the desired glass transition temperature.

Further, in the present embodiment, the curing agent (i.e., component B) is an isocyanate hardener having isocyanate (—NCO) functional groups. The curing agent is mixed with the acrylic resin immediately prior to the coating process of the surface treatment agent, thereby initiating a curing reaction of the acrylic resin. The isocyanate functional groups of the curing agent can react with the hydroxyl groups and the amino groups included in the acrylic resin, which can enhance the degree of crosslinking in the coating layer (coating film), thereby improving the hardness of the resultant coating layer.

The isocyanate hardener can be, for example, at least one selected from the group consisting of hexamethylene diisocyanate (HDI), methylene diphenyl diisocyanate (MDI), toluene diisocyanate (TDI), meta-xylylene diisocyanate (mXDI), isophorone diisocyanate (IPDI), and hydrogenated MDI (H12MDI). For example, the isocyanate hardener is hexamethylene diisocyanate (HDI), but the present disclosure is not limited thereto.

An amount of the curing agent (i.e., isocyanate hardener) ranges from 35 parts by weight to 65 parts by weight and preferably ranges from 48 parts by weight to 56 parts by weight.

The weight ratio of the curing agent to the main agent is controlled within the above-mentioned range to prevent excessive gelation or aggregation of the coating layer, which could adversely affect the appearance of the coating layer.

In one embodiment of the present disclosure, the main agent of the surface treatment agent further includes matting powder(s) dispersed in the acrylic resin. It should be noted that “matting powder” as used herein may include one or more types of powder unless otherwise specified.

The matting powder is silica matting powder, preferably silica matting powder prepared by a fumed process, and has an average particle diameter (d50) ranging from 5 μm to 15 μm (e.g., 9.5 μm), a pH value ranging from 6 to 7, a tamped density ranging from 40 g/L to 60 g/L (e.g., 50 g/L) measured according to ISO 787-11, and a silica content of not less than 99% measured according to ISO 3262-19 (e.g., 99.8%).

In one embodiment of the present disclosure, the matting powder adopts ACEMATT® TS100 (commercially available from EVONIK), which has a particle size of 9.5 μm, a pH value of 6.5, and can provide a gloss value ranging from 4 GU to 6 GU, measured at 600 in accordance with ASTM D523, which meets the requirements of the final product. It is worth mentioning that not all the commercially available matting powder can meet suitable gloss requirements. For example, matting powders such as ACEMATT® 810, ACEMATT® 3600, and ACEMATT® 3300 fail to meet the end-use gloss requirements due to insufficient matting performance.

An amount of the matting powder ranges from 30 parts by weight to 60 parts by weight, and preferably ranges from 42 parts by weight to 53 parts by weight.

The weight ratio of the matting powder to the main agent should be controlled within the above range to provide sufficient matting effect and avoid agglomeration. The addition of silica matting powder is suitable for matte surface treatment agents.

Based on the addition of the matting powder, the coating layer (coating film) formed by applying the surface treatment agent on a substrate has a gloss value of not greater than 6 GU, preferably ranging from 4 GU to 6 GU. The gloss value is tested according to ASTM D523 using a gloss meter at a measuring angle of 600 or 850 (preferably 60°). In other words, the resulting coating layer (coating film) exhibits a matte appearance with sufficient matting performance.

In another embodiment of the present disclosure, the main agent of the surface treatment agent further includes a leveling agent dispersed in the acrylic resin. To prevent undesirable coating appearance issues such as orange peel or surface waviness after coating, the leveling agent can be added when mixing the acrylic resin with the matting powder, thereby improving the surface smoothness of the resulting coating layer (coating film). Due to the relatively fluffy nature of the matting powder (e.g., silica matting powder), viscosity tends to increase, necessitating appropriate adjustments to the solvent or leveling agent proportions to ensure thorough mixing and smooth application.

The leveling agent can be, for example, a silicone-based leveling agent or a non-silicone-based leveling agent. The silicone-based leveling agent can be, for example, polydimethylsiloxane (PDMS)-based leveling agent. In addition, the non-silicone-based leveling agent can be, for example, a polyether-based leveling agent or a low-surface-tension surfactant.

An amount of the leveling agent ranges from 0.5 parts by weight to 10 parts by weight, preferably from 1 part by weight to 7 parts by weight, and more preferably from 2 parts by weight to 6 parts by weight.

### [Method of Using Surface Treatment Agent]

The foregoing provides the material characteristics of the surface treatment agent according to embodiments of the present disclosure. The following describes a method of using the surface treatment agent according to one embodiment of the present disclosure, which includes steps S110 and S120.

Step S110 is to perform a coating material preparation process that includes mixing the main agent (i.e., acrylic resin) and the curing agent (i.e., isocyanate hardener) included in the surface treatment agent (i.e., the two-component agent). The main agent contains the afore-mentioned matting powder (e.g., silica matting powder) and leveling agent, and the coating material is formulated according to the afore-mentioned weight ratios to complete the coating material preparation.

Step S120 is to perform a coating and curing process that includes coating the coating material onto a surface of a substrate (e.g., a wood grain board) and conducting a curing operation such as baking or ultraviolet (UV) irradiation, so as to form a matte hardened coating layer (coating film). As described above, the matte hardened coating layer formed of the surface treatment agent has a gloss value of not greater than 6 GU, and preferably between 4 GU and 6 GU.

### [Experimental Data and Test Results]

The following describes the content of the present disclosure in detail with reference to exemplary examples and comparative examples. Exemplary examples demonstrate experimental groups that support the technical effects of the present disclosure, while the comparative examples represent groups with inferior performance. However, the following embodiments are merely provided to facilitate understanding of the present disclosure, and the scope of the present disclosure is not limited to these embodiments.

Exemplary Example 1: According to the conditions in Table 1, the acrylic monomers, including the first monomer (MMA), the second monomer (2-HEMA), the third monomer (EGDMA), the fourth monomer (DMAEMA), the fifth monomer (2-EHA), and the initiator (AIBN), are dispersed in an organic solvent mixture including MEK, BAC, and PMA, to form a monomer solution. The polymerization reaction is carried out at a reaction temperature of 80 °C using a semi-batch method, thereby forming the acrylic resin. The polymerization reaction includes a first stage and a second stage. In the first stage, 20% (by volume) of the monomer solution is added dropwise within 30 minutes. In the second stage, the remaining 80% of the monomer solution is added dropwise within 3 hours. Subsequently, the matting powder and the leveling agent are added to the acrylic resin to form the main agent (component A). The main agent is then mixed with the curing agent (component B, HDI) to prepare the coating material. The coating material is then applied onto a surface of a wood grain board and subjected to UV irradiation to form a matte hardened coating layer (coating film). Finally, the thickness, pencil hardness, and gloss value of the coating layer are tested, and the results are recorded in Table 1.

Exemplary Examples 2 to 3: The preparation method of the acrylic resin in each of Exemplary Examples 2 to 3 is substantially the same as in Exemplary Example 1, except for differences in component ratios or reaction conditions (as shown in Table 1).

Comparative Examples 1 to 2: The main differences between the Comparative Examples 1 to 2 and the above exemplary examples are that: Comparative Example 1 does not include the third monomer (EGDMA), and in Comparative Example 2, the amount of matting powder is relatively low (24 parts by weight), which does not fall within the specified range of 30 to 60 parts by weight.

TABLE 1

| | Exem- | Exem- | Exem- | Compar- | Compar- |
|---|---|---|---|---|---|
| | plary | plary | plary | ative | ative |
| | Example 1 | Example 2 | Example 3 | Example 1 | Example 2 |
| Acrylic | | | | | |
| Monomers | | | | | |
| MMA | 100 | 100 | 100 | 100 | 100 |
| (parts by | | | | | |
| weight) | | | | | |
| 2-HEMA | 44 | 36 | 38 | 44 | 44 |
| (parts by | | | | | |
| weight) | | | | | |
| EGDMA | 5 | 4 | 6 | 0 | 5 |
| (parts by | | | | | |
| weight) | | | | | |
| DMAEMA | 14 | 18 | 2 | 14 | 14 |
| (parts by | | | | | |
| weight) | | | | | |
| 2-EHA | 9 | 16 | 6 | 9 | 9 |
| (parts by | | | | | |
| weight) | | | | | |
| Additives | | | | | |
| Initiator | 5 | 5 | 5 | 5 | 5 |
| (parts by | | | | | |
| weight) | | | | | |
| Matting | 48 | 49 | 49 | 48 | 24 |
| powder | | | | | |
| (parts by | | | | | |
| weight) | | | | | |
| Leveling | 4 | 4 | 4 | 4 | 4 |
| agent | | | | | |
| (parts by | | | | | |
| weight) | | | | | |
| Solvents | | | | | |
| MEK | 60 | 60 | 80 | 60 | 60 |
| (parts by | | | | | |
| weight) | | | | | |
| BAC | 90 | 90 | 88 | 90 | 90 |
| (parts by | | | | | |
| weight) | | | | | |
| PMA | 80 | 80 | 84 | 80 | 80 |
| (parts by | | | | | |
| weight) | | | | | |
| Resin | | | | | |
| Weight | 21,080 | 20,586 | 24,263 | 15,303 | 21,080 |
| average | | | | | |
| molecular | | | | | |
| weight Mw | | | | | |
| (g/mol) | | | | | |
| Glass | 45.89 | 40.64 | 47.9 | 31.94 | 45.89 |
| transition | | | | | |
| temperature | | | | | |
| Tg (°C) | | | | | |
| Curing | 52 | 53 | 53 | 52 | 52 |
| agent | | | | | |
| (parts by | | | | | |
| weight) | | | | | |
| Coating | | | | | |
| Layer | | | | | |
| Coating | 6.6 | 6.75 | 6.3 | 6.42 | 5.3 |
| thickness | | | | | |
| (μm) | | | | | |
| Pencil | 4H | 3H | 4H | HB | 4H |
| hardness | | | | | |
| (6B-7H) | | | | | |
| Gloss value | 5.4 | 5.7 | 5.0 | 5.2 | 16.9 |
| (GU) | | | | | |

From the experimental results, it is evident that the coating layers (coating films) in Exemplary Examples 1 to 3 exhibit both superior scratch resistance (not less than 31H-41H in pencil hardness) and a high degree of matting (gloss value not exceeding 6). These results confirm that through the monomer formulation and controlled experimental conditions of the embodiment of the present disclosure, especially with an EGDMA to MMA ratio between 0.04 and 0.06, an optimal molecular weight and Tg can be achieved. This effectively solves the issue of insufficient scratch strength while maintaining high matting levels and providing excellent tactile feel.

In contrast, Comparative Example 1, which does not include EGDMA in the monomer formulation, exhibits inferior performance in pencil hardness (only HB). Comparative Example 2 contains an insufficient amount of matting powder (24 parts by weight), resulting in inadequate matting performance.

### [Surface Treatment Agent of Second Embodiment]

A second embodiment of the present disclosure further provides a surface treatment agent. The surface treatment agent is a two-component treatment agent including a main agent (i.e., component A) and a curing agent (i.e., component B). The main agent includes an acrylic resin formed by copolymerization of an acrylic monomer composition. The acrylic monomer composition includes: a first monomer (a), a second monomer (b), a third monomer (c), a fourth monomer (d), and a fifth monomer (e). The differences between the surface treatment agent of the second embodiment and that of the first embodiment are described below (each monomer may have alternative selections).

The first monomer (a) is a methacrylate monomer selected from the group consisting of methyl methacrylate (MMA), ethyl methacrylate (EMA), and isobornyl methacrylate (IBOMA). EMA has a chemical structure similar to MMA and provides good film-forming and physical properties. IBOMA, due to its rigid structure, can improve the glass transition temperature (Tg) and scratch resistance of the resin, which is suitable for surface treatments requiring higher abrasion resistance.

The second monomer (b) is a hydroxyl-containing methacrylate monomer selected from the group consisting of 2-hydroxyethyl methacrylate (2-HEMA), hydroxypropyl methacrylate (HPMA), and hydroxybutyl methacrylate (HBMA). The hydroxyl groups (—OH) in these monomers help to enhance the chemical bonding strength and adhesion between the coating layer (coating film) and the substrate and can also crosslink with other functional monomers to improve the durability of the resulting coating layer.

The third monomer (c) is a crosslinkable methacrylate monomer having bifunctional groups, selected from the group consisting of ethylene glycol dimethacrylate (EGDMA), 1,6-hexanediol diacrylate (HDDA), and diethylene glycol dimethacrylate (DEGDMA). These bifunctional crosslinking methacrylate monomers can increase the crosslinking density of the resin during polymerization, thereby enhancing the hardness, scratch resistance, and dimensional stability of the coating layer.

The fourth monomer (d) is a basic functional methacrylate monomer selected from the group consisting of 2-(dimethylamino)ethyl methacrylate (DMAEMA), 2-(diethylamino)ethyl methacrylate (DEAEMA), and 3-(dimethylamino)propyl methacrylate (DMAPMA). These amine-functional monomers provide basicity and hydrophilicity and can also further crosslink with hydroxyl-containing monomers or isocyanate curing agents to enhance the stability of the coating film.

The fifth monomer (e) is a long-chain aliphatic acrylate monomer selected from the group consisting of 2-ethylhexyl acrylate (2-EHA), butyl acrylate (BA), and isooctyl acrylate (IOA). These monomers provide moderate flexibility and impact resistance to prevent cracking of the coating layer (coating film). The selection and amount of these monomers can be adjusted based on the actual requirements for softness and elasticity in the application.

The acrylic resin is formed by copolymerizing the above acrylic monomer composition. The acrylic resin, prior to coating and reacting with the curing agent, is in a liquid or flowable state and has a glass transition temperature (Tg) ranging from 20 °C to 60 °C, preferably from 25 °C to 55 °C, and more preferably from 40 °C to 50 °C.

The acrylic resin has a weight average molecular weight (Mw) ranging from 10,000 to 35,000 g/mol, preferably from 15,000 to 30,000 g/mol, and more preferably from 15,000 to 25,000 g/mol.

The curing agent (i.e., component B) is an isocyanate hardener having —NCO functional groups.

### Advantages of the Embodiments

In conclusion, the coating layer formed of the surface treatment agent according to the embodiment of the present disclosure exhibits improved scratch resistance while maintaining a high level of matting and appropriate tactile feel. The surface treatment agent is applicable to wood grain building materials that require high abrasion resistance.

It should be noted that chemical documents related to compositions commonly employ two expressions: “parts by weight” and “weight percent (wt %)”. The notation “parts by weight” represents the proportional relationships among components. Consequently, unlike the “weight percent” notation, the “parts by weight” notation does not require adherence to the two boundary conditions formulas, nor does it require that the sum of percentages in an embodiment must equal exactly 100%. The two boundary conditions formulas referenced herein are: (1) the sum of the upper-limit value of one component plus the lower-limit values of all remaining components must be less than or equal to 100%; and (2) the sum of the lower-limit value of one component plus the upper-limit values of all remaining components must be greater than or equal to 100%. When converting parts by weight into weight percentages, a reference basis representing the total composition must be clearly defined, and compliance with these boundary conditions is necessary. As an illustrative example, a composition containing 50 parts by weight of component A and 20 parts by weight of component B would correspondingly translate to a composition comprising 50/(50+20) wt % of component A and 20/(50+20) wt % of component B. For instance, in an embodiment where monomer X ranges from 1 to 3 parts by weight, converting this to weight percentages based on a total of 230 parts by weight results in approximately 0.40 wt % to 1.30 wt % (relative to 100 wt % of the primary monomer).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A surface treatment agent suitable for being applied on surfaces of wood grain building materials, wherein the surface treatment agent is a two-component treatment agent that comprises:
a main agent including an acrylic resin that is formed by a copolymerization reaction of an acrylic monomer composition; and
a curing agent, which is an isocyanate hardener;
wherein the acrylic monomer composition includes:
a first monomer, which is methyl methacrylate (MMA);
a second monomer, which is 2-hydroxyethyl methacrylate (2-HEMA);
a third monomer, which is ethylene glycol dimethacrylate (EGDMA);
a fourth monomer, which is 2-(dimethylamino)ethyl methacrylate (DMAEMA); and
a fifth monomer, which is 2-ethylhexanoic acid (2-EHA);
wherein the acrylic resin has a glass transition temperature ranging from 20 °C to 60 °C and a weight average molecular weight ranging from 10,000 g/mol to 35,000 g/mol.

2. The surface treatment agent according to claim 1, wherein, in the acrylic monomer composition, based on 100 parts by weight of the first monomer (MMA), an amount of the second monomer (2-HEMA) ranges from 30 to 50 parts by weight, an amount of the third monomer (EGDMA) ranges from 1 to 10 parts by weight, an amount of the fourth monomer (DMAEMA) ranges from 1 to 25 parts by weight, and an amount of the fifth monomer (2-EHA) ranges from 1 to 25 parts by weight.

3. The surface treatment agent according to claim 2, wherein, in the main agent, the acrylic monomer composition further includes a sixth monomer, which is styrene or a styrene-containing monomer, and wherein an amount of the sixth monomer ranges from 1 to 10 parts by weight.

4. The surface treatment agent according to claim 1, wherein the acrylic resin has the glass transition temperature ranging from 25 °C to 55 °C and the weight average molecular weight ranging from 15,000 to 30,000 g/mol.

5. The surface treatment agent according to claim 4, wherein the acrylic resin has the glass transition temperature ranging from 40 °C to 50 °C and the weight average molecular weight ranging from 15,000 to 25,000 g/mol.

6. The surface treatment agent according to claim 1, wherein the acrylic resin is formed by the copolymerization reaction of the acrylic monomer composition in the presence of an organic solvent and an initiator.

7. The surface treatment agent according to claim 1, wherein an amount of the curing agent ranges from 35 parts by weight to 65 parts by weight.

8. The surface treatment agent according to claim 1, further comprising:
a matting powder, wherein the matting powder is silica matting powder having an average particle size (d50) ranging from 5 μm to 15 μm, a tamped density ranging from 40 to 60 g/L according to ISO 787-11, and a silica content of not less than 99% according to ISO 3262-19.

9. The surface treatment agent according to claim 8, wherein an amount of the matting powder ranges from 30 parts by weight to 60 parts by weight.

10. A method of using a surface treatment agent, comprising:
performing a coating material preparation process, including mixing the main agent and the curing agent of the surface treatment agent as claimed in claim 1 to form a coating material; and
performing a coating and curing process, including coating the coating material onto a surface of a substrate and curing the coating material to form a coating layer;
wherein the coating layer includes a silica matting powder and has a gloss value of not greater than 6 GU.

11. A surface treatment agent suitable for being applied on surfaces of wood grain building materials, wherein the surface treatment agent is a two-component treatment agent that comprises:
a main agent including an acrylic resin that is formed by a copolymerization reaction of an acrylic monomer composition; and
a curing agent, which is an isocyanate hardener;
wherein the acrylic monomer composition includes:
a first monomer, which is a methacrylate monomer;
a second monomer, which is a hydroxyl-containing methacrylate monomer;
a third monomer, which is a crosslinkable methacrylate monomer having bifunctional groups;
a fourth monomer, which is a basic functional methacrylate monomer; and
a fifth monomer, which is a long-chain aliphatic acrylate monomer;
wherein the acrylic resin has a glass transition temperature ranging from 20 °C to 60 °C and a weight average molecular weight ranging from 10,000 to 35,000 g/mol.
